(19) United States
(12) Patent Application Publication
(10) Pub. No.: US 2008/0154758 A1
(43) Pub. Date: Jun. 26, 2008

(54) Systems and methods for maintaining credit information about an entity

(76) Inventors: Friedrich Schattmaier, Nussloch (DE); Mohamad El-Saadi, Nussloch (DE)

Correspondence Address: SAP / FINNEGAN, HENDERSON LLP, 901 NEW YORK AVENUE, NW, WASHINGTON, DC, 20001-4413, US

(21) Appl. No.: 11/642,826

(22) Filed: Dec. 21, 2006

(51) Int. Cl. G06Q 40/00

(52) U.S. Cl. 705/35

(57) ABSTRACT

Systems and methods are provided for maintaining credit information that relates to one or more entities. In one implementation, a credit report is received from a credit-information provider to establish one or more units of credit information, each of the units of credit information relating to an entity. Further, a credit-report update is received from the credit-information provider, the credit-report update comprising a unit of update information that relates to an entity. It is determined whether the unit of update information corresponds to one of the units of established credit information. If there is correspondence, the corresponding unit of credit information is updated according to the unit of update information.

### TECHNICAL FIELD

The present invention generally relates to systems and methods for maintaining credit information about an entity, such as a business partner. More particularly, and without limitation, the invention relates to systems and methods for automatically updating credit information at a user based on credit-report updates.

### BACKGROUND INFORMATION

Businesses commonly use credit information about their current or prospective business partners to make business-related decisions in relation to those business partners. The business may request the credit information from one or more credit reporting agencies. Typically, the credit reporting agency has compiled the credit information in a predetermined manner based on a financial history of the business partner, such as a credit history, that the credit reporting agency maintains. The credit information may indicate a degree of risk associated with the business partner, such as a degree of credit-worthiness of the business partner. The credit reporting agency provides the credit information to the business in the form of a report, referred to as a “credit report.”

The business may need to make business-related decisions in relation to the same business partner on multiple occasions. On each occasion, it may be advantageous for the business to possess credit information that is as up-to-date as possible. For example, recent events in the financial history of the business partner may adjust the business partner's degree of credit-worthiness or other associated risk. Therefore, the business may request an up-to-date credit report from the credit reporting agency in order to be able to take these adjustments into consideration when making its business-related decisions.

However, re-transmitting the entire credit report on every occasion that it is needed by the business, in order to maintain the up-to-date credit information, may use resources inefficiently. For example, the financial history maintained by the credit reporting agency in relation to the business partner may not have changed since the business most recently requested the credit report for the business partner. Unfortunately, the business may not know whether its credit information is up-to-date. Thus, the business may unnecessarily make a new request for the credit report from the credit reporting agency in order to insure that the credit information is up-to-date.

Furthermore, each time the up-to-date credit report is transmitted to the business, an agent, such as a person or computer system, at the business may need to process the entirety of the credit report in order to update its credit information. Repeatedly processing the entirety of each credit report may waste labor and/or computer resources at the business.

In addition, a credit reporting agency may charge a fixed fee to the business each time a credit report is transmitted. For example, the credit reporting agency may not distinguish between a business that is making a first request for a credit report related to a business partner and a business that is making a repeated request for the credit report in order to insure that its credit information is up-to-date. In this case, the business may be making payments for the credit reports that are excessive, and even prohibitive, when compared to the useful information that the business is receiving from the credit reporting agency in the repeated transmissions of the credit report.

Thus, it is desirable to have systems and methods for automatically updating credit information that a user maintains in relation to an entity, such as a business partner. It is further desirable to have systems and methods for updating the credit information in a manner that efficiently uses transmissions between the user and providers of the credit information.

### SUMMARY

Consistent with embodiments of the invention, systems and methods are provided for maintaining credit information that relates to one or more entities. Embodiments of the invention may automatically and efficiently update the credit information that are maintained about an entity. Embodiments of the invention include computer-implemented systems and methods, as well as computer readable media including instructions that perform methods consistent with the invention when implemented by a computer or processor.

In accordance with one embodiment, a method is provided for maintaining credit information that relates to one or more entities. The method may comprise receiving a credit report from a credit-information provider to establish one or more units of credit information, each of the units of credit information relating to an entity. Further, a credit-report update may be received from the credit-information provider, the credit-report update comprising a unit of update information that relates to an entity. According to the method, it may be determined whether the unit of update information corresponds to one of the units of established credit information. If there is correspondence, the corresponding unit of credit information may be updated according to the unit of update information.

In accordance with another embodiment, a system is provided for maintaining credit information that relates to one or more entities. The system may comprise a credit-management system to receive a credit report from a credit-information provider to establish one or more units of credit information, each of the units of credit information relating to an entity. Further, the credit-management system may receive a credit-report update from the credit-information provider, the credit-report update comprising a unit of update information that relates to an entity. The credit-management system may determine whether the unit of update information corresponds to one of the units of established credit information. If there is correspondence, the credit-management system may update the corresponding unit of credit information according to the unit of update information. The system may further comprise a data storage to store the credit information.

In accordance with yet another embodiment, a computer-readable medium is provided that comprises programmable instructions adapted to perform a method of maintaining credit information that relates to one or more entities. The method may comprise receiving a credit report from a credit-information provider to establish one or more units of credit information, each of the units of credit information relating to an entity. Further, a credit-report update may be received from the credit-information provider, the credit-report update comprising a unit of update information that relates to an entity. According to the method, it may be determined whether the unit of update information corresponds to one of the units of established credit information. If there is correspondence, the corresponding unit of credit information may be updated according to the unit of update information.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments consistent with the present invention may be directed to various combinations and sub-combinations of the features described in the following detailed description.

### BRIEF DESCRIPTION OF THE DRAWINGS

The accompanying drawings, which are incorporated in and constitute a part of this specification, illustrate embodiments of the invention and, together with the description, serve to explain advantages and principles of the invention. In the drawings:

FIG. 1 is a schematic diagram of an exemplary embodiment, consistent with the present invention, of a user with a credit-management system, a plurality of entities, and a credit-information provider;

FIG. 2 is a schematic diagram of an exemplary embodiment, consistent with the present invention, of (i) a data structure of a credit-report-update request that is transmitted from a credit-management system to a credit-information provider, and (ii) a data structure of a credit-report update that is transmitted from the credit-information provider to the credit-management system;

FIG. 3 is a flowchart of an exemplary embodiment, consistent with the present invention, of a method of updating credit information at a user by requesting, receiving, and parsing a credit-report update, and updating the credit information according to the parsed credit-report update; and

FIG. 4 is a schematic diagram of an exemplary embodiment, consistent with the present invention, of a computer that includes a computer-readable medium having programmable instructions to update credit information by requesting a credit-report update, parsing the credit-report update, and updating credit information according to the parsed credit-report update.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Consistent with the present invention, a user may use credit information to assess a degree of risk associated with an entity to help make a business-related decision in relation to that entity. The user may be a business, an individual, or another type of user of the credit information. The entity is an entity, such as a company or individual, with whom the user currently does business or may prospectively do business. Typically, the user engages a credit-information provider, such as a credit reporting agency, to provide some or all of the credit information about the entity. Actual examples of credit reporting agencies include Dun & Bradstreet of Short Hills, N.J., and Creditreform of Neuss, Germany.

The user may request a credit report from the credit-information provider in relation to the entity. The credit report comprises a compilation of a full or partial financial history of one or more entities or information derived from such financial history. For example, the credit report may comprise a data file, one or more formal credit reports, or another form of compilation. The credit-information provider may hold the financial history of the entity, and/or may obtain the financial history from third-party sources. The financial history may include data about the entity that is relevant to the user in making a business-related decision concerning the entity. For example, the financial history may include a credit history, a bank account history, a credit score, a financial statement, financial information about a business or individual related directly or indirectly to the entity.

The user may use, in addition to the credit report, locally-originated information about the entity to assess a degree of risk associated with the entity. For example, the user may retrieve information from local transactional systems that maintain information about the entity. These local transactional systems may include one or more of customer relationship management (CRM) systems, sales and distribution (SD) systems, and financial systems.

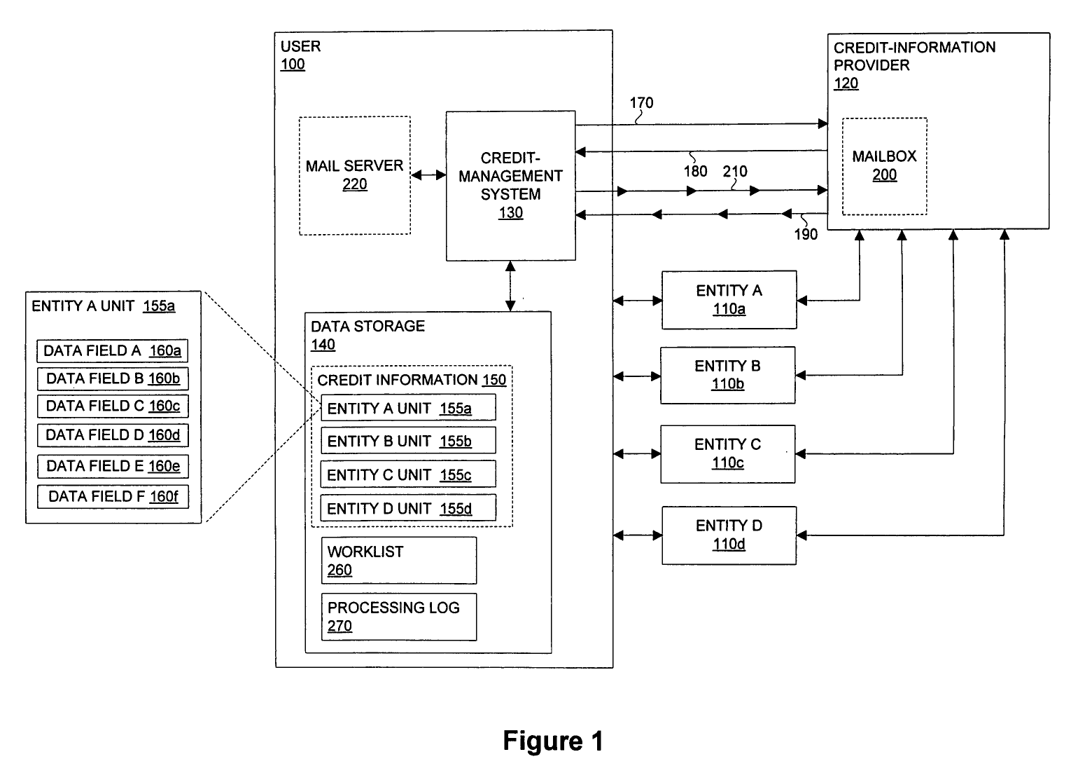

FIG. 1 is a block diagram of an exemplary embodiment, consistent with the present invention, of a user 100, current or prospective entities (referenced as “A” through “D”) 110a-110d of user 100, and a credit-information provider 120 to provide credit information 150 about entities 110a-110d to user 100. Credit information 150 may contain distinguishable units of information, referred to herein as entity units 155a-155d, that individually relate to entities 110a-110d, respectively. For example, each of entity units 155a-155d may be linked to an object in user 100 that embodies a record of each of entities 110a-110d, respectively.

User 100 may include a credit-management system 130 to manage credit information 150, such as to establish and then update credit information 150. User 100 may also have a data storage 140 in which credit information 150 is stored. In addition, credit-management system 130 may be adapted to evaluate entity units 155a-155d of credit information 150 to determine risks associated with respective entities 110a-110d.

Each of entity units 155a-155d may contain a plurality of distinguishable data fields. A plurality of data fields 160a-160f, contained in entity unit 155a and relating to entity 110a, are shown in an exploded view in FIG. 1 for the purposes of illustration. Each of data fields 160a-160f is a set of data of a predetermined data type. Further, each of entity units 155a-155d may have one or more data fields of the same data type. Illustrative examples of the data contained in an individual data field may include a name of an individual or a credit lender, a date, an address, a time duration, an amount of a payment, a credit score, information about a credit inquiry, or an indication that a payment was overdue.

Credit information 150 may be established, in relation to one or more of entities 110a-110d, fully or partially based on an original credit report received from credit-information provider 120 by credit-management system 130. When credit-management system 130 does not have credit information 150 about an entity 110a-110d from credit-information provider 120, credit-management system 130 may use the original credit report to initially establish credit information 150 about that entity. In operation, credit-management system 130 may generate a request 170 to receive an original credit report 180 describing one or more of entities 110a-110d and transmit request 170 to credit-information provider 120. In response, credit-information provider 120 may transmit credit report 180 to credit-management system 130 to establish credit information 150 about those entities identified in request 170.

After credit-management system 130 has established credit information 150 about entities 110a-110d, credit-information provider 120 may selectively monitor entities 110a-110d to update credit information 150 at user 100. Selectively monitoring the financial history of an entity refers to detecting preselected types of new information in the financial history of the entity. The preselected types of new information are relevant to credit information 150 at user 100. For example, the new information may include a recent development or discovery in the financial history that is relevant to user 100. Detecting the new information may occur at one time, such as upon request by credit-management system 130, or may occur continuously.

In accordance with one embodiment, credit-information provider 120 monitors the entity for new information arising within a preselected amount of time after credit-information provider 120 provides original credit report 180 to credit-management system 130 in relation to that entity. For example, credit-information provider 120 may monitor that entity for a time period of from about 6 months to about 2 years, such as about 1 year, from the time that credit information 150 was initially established about that entity.

To cause credit information 150 to be updated at credit-management system 130, credit-information provider 120 may generate credit-report updates 190 and transmit credit-report updates 190 to credit-management system 130 for processing. In accordance with one embodiment, credit-report updates 190 may be transmitted as part of an online process between credit-management system 130 and credit-information provider 120. Alternatively, credit-report updates 190 may be transmitted as part of batch processing between credit-management system 130 and a plurality of credit-information providers, in which a credit-report update is received from each of the credit-information providers.

Each of credit-report updates 190 may contain update information for one or more of entities 110a-110d to cause credit information 150 to be updated in relation to those entities. The update information in each of credit-report updates 190 may have data types that are a subset of the data types of credit information 150. The update information may also have data types that are not data types of credit information 150. Meanwhile, for each of credit-report updates 190, there may be data types of credit information 150 that are not data types of the update information in that credit-report update. For example, credit-report updates 190 may update data fields, such as data fields 160a-160f, or insert new data fields in credit information 150 in relation to those entities. Meanwhile, certain data fields in credit information 150 may be left unchanged by credit-report updates 190.

In accordance with one embodiment, referred to as a “pull” scheme, credit-management system 130 requests credit-report updates 190 from credit-information provider 120. In this embodiment, credit-management system 130 “pulls” credit-report updates 190 from credit-information provider 120. Credit-information provider 120 may include a mailbox 200 in which credit-information provider 120 deposits credit-report updates 190 for retrieval by credit-management system 130. For example, mailbox 200 may be reserved for exclusive use by credit-management system 130. Mailbox 200 is shown in FIG. 1 as a component of credit-information provider 120 that may optionally be provided to implement a “pull” scheme. In operation, credit-management system 130 may generate a credit-report-update request 210 to receive credit-report update 190 for updating credit information 150. Credit-management system 130 may then transmit credit-report-update request 210 to credit-information provider 120. Credit-information provider 120 may have previously generated credit-report update 190 upon a change in the financial history of a monitored entity, or it may generate credit-report update 190 upon receiving credit-report-update request 210. Credit-information provider 120 may deposit credit-report update 190 in mailbox 200, from which credit-report update 190 may be transmitted to credit-management system 130 upon receiving credit-report-update request 210.

Alternatively or in addition, credit-information provider 120 may send credit-report updates 190 to credit-management system 130 absent credit-report-update requests 210 from credit-management system 130. This embodiment may be referred to as a “push” scheme because credit-information provider 120, on its own initiative, “pushes” credit-report updates 190 to credit-management system 130. User 100 may include a mail server 220 to receive credit-report updates 190 from credit-information provider 120. Mail server 220 is shown in FIG. 1 as a component of user 100 that may optionally be provided to implement a “push” scheme. In operation, credit-information provider 120 may decide to generate and transmit credit-report update 190 to credit-management system 130. For example, credit-information provider 120 may provide credit-report update 190 to credit-management system 130 upon detecting a change in the financial history of a monitored entity. In further examples, credit-information provider 120 may provide credit-report update 190 after a preselected amount of time has elapsed, or upon receiving another type of trigger to cause credit information 150 to be updated.

In accordance with one embodiment, credit-management system 130 and credit-information provider 120 communicate with each other by means of Extensible Markup Language (XML) messages within a suitable interface, such as the Internet. For example, credit-management system 130 may format request 170 or credit-report-update requests 210 as XML messages. Credit-management system 130 may transmit these XML-formatted requests to credit-information provider 120. In response, credit-information provider 120 may prepare credit report 180 or credit-report updates 190, respectively, as XML messages and transmit the XML-formatted credit report or credit-report updates to credit-management system 130. The sizes of the XML-formatted credit report 180 or credit-report updates 190 may be configured according to the types of credit information being transmitted, and credit-management system 130 may be adapted to parse these size-configurable XML-formatted messages. For example, an XML-formatted credit-report update may update substantially the entirety of credit information 150 held by credit-management system 130, or an XML-formatted credit-report update may update only parts of credit information 150 that relate to selected one or more of entities 110a-110d.

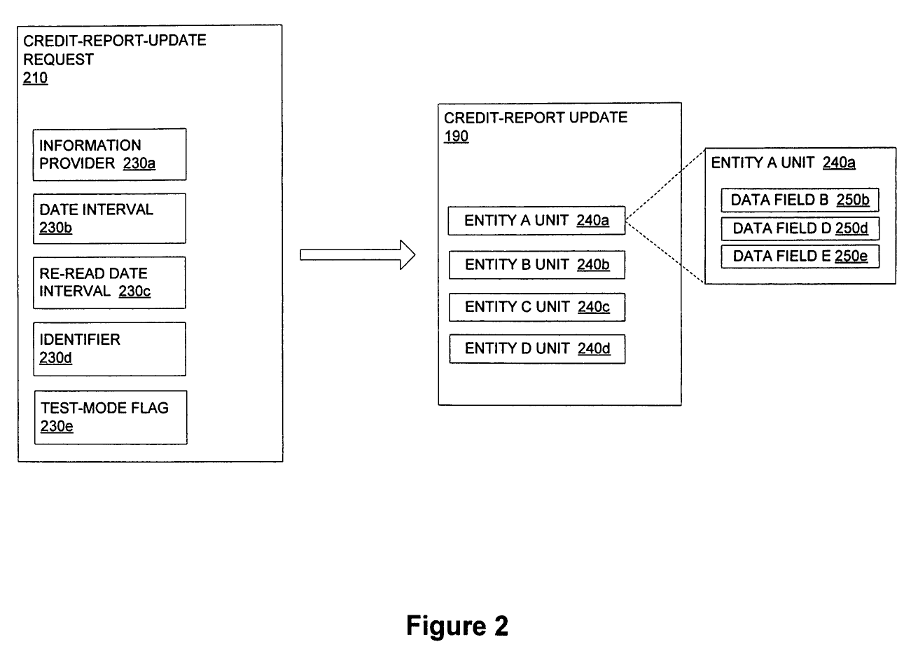

FIG. 2 is a schematic diagram, consistent with the present invention, of exemplary data structures of credit-report update 190 and credit-report-update request 210. As represented by the arrow in FIG. 2, credit-report-update request 210 may be used to retrieve credit-report update 190. Credit-report-update request 210 may include an “information provider” entry 230a to identify the credit-information provider from which credit-report update 190 is to be received. A “date interval” entry 230b may be provided to specify a date interval such that new information arising within this date interval will be included as update information in credit-report update 190. A “re-read date interval” entry 230c may also be provided to specify a date interval for update information that is to be included in credit-report update 190 in the event of a re-read. A re-read may be requested when there is a loss of update information at the credit management system, such as if the update information is deleted by a human operator or becomes corrupted. Credit-report-update request 210 may further have an “identifier” entry 230d to identify specific sets of update information, such as entity units or data fields, that are to be included in credit-report update 190. For example, “identifier” entry 230d may identify one or more entities for which update information is desired. “Identifier” entry 230d may additionally or alternatively identify selected instances of data fields that are to be updated or newly created for particular entities. Furthermore, “identifier” entry 230d may identify the relevant entities using a proprietary code of the credit-information provider, such as a “DUNS-number” for Dun & Bradstreet or a “Creditreform mailbox ID” for Creditreform. In addition, a “test-mode flag” entry 230e may be provided to enable the requesting and processing of the credit-report-update request 210 in a test mode without actually causing an update of the credit information maintained by the credit-management system. If the credit-information provider registers whether the update information has been retrieved in a flag, the test mode may leave this flag in an “unread” status indicating that the update information has not been retrieved; this may be useful for testing purposes since making repeated credit-report-update requests within a small time period may predictably result in receiving the same credit-report update.

Credit-report update 190 contains update information that is used to update the credit information at the credit-management system. Similarly to the way that entity units of credit information in the credit-management system may correspond to individual entities, credit-report update 190 may contain entity units 240a-240d of update information that correspond to individual entities. Each of entity units 240a-240d may further be organized into a plurality of distinct data fields. A plurality of data fields 250b, 250d, and 250e, contained in entity unit 240a, are shown in an exploded view in FIG. 2 for the purposes of illustration. Each of data fields 250b, 250d, and 250e is a set of data of a predetermined data type. For example, each of entity units 240a-240d may have one or more data fields of the same data type.

Returning to FIG. 1, upon receiving credit-report update 190, credit-management system 130 processes credit-report update 190 to update credit information 150. Credit-report update 190 may be one of a plurality of credit-report updates contained in a collection of update information that is received from credit-information provider 120, and credit-management system 130 may parse the collection of update information to allocate credit-report update 190 to credit information 150. For example, credit-report update 190 and credit information 150 may correspond to a particular credit information product offered by a credit reporting agency. Credit-management system 130 may also parse credit-report update 190 to allocate the entity units in credit-report update 190 to corresponding entity units 155a-155d in credit information 150. Furthermore, for each of entities 110a-110d, credit-management system 130 may allocate particular data fields of credit-report update 190 to corresponding data fields of credit information 150. For example, data fields 250b, 250d, and 250e shown in FIG. 2, which are part of credit-report update 190, correspond to data fields 160b, 160d, and 160e shown in FIG. 1, which are part of credit information 150.

After parsing credit-report update 190, credit-management system 130 may update credit information 150 based on the allocated entity units and data fields from credit-report update 190. In accordance with one embodiment, credit-management system 130 iteratively reads each of the allocated entity units in credit-report update 190 and updates each of corresponding entity units 155a-155d in credit information 150 according to its allocated entity unit in credit-report update 190. For each of the allocated entity units, credit-management system 130 may iteratively read each of the data fields in the allocated entity unit and update each of the corresponding data fields in credit information 150.

Although credit-management system 130 may operate automatically, it may also display messages to a human operator by means of a user interface (UI) and receive input from the operator. The operator may be a person at user 100 who is responsible for the operation of credit-management system 130. In accordance with one embodiment, credit-management system 130 displays a progress of processing credit-report update 190 to the operator and enables the operator to manually intervene in the processing. For example, credit-management system 130 may enable the operator to interrupt the processing of credit-report update 190. The operator may then take steps to manually allocate the update information in credit-report update 190 and/or manually update credit information 150 in credit-management system 130. In another example, the operator may be notified if credit-management system 130 fails to automatically allocate an entity unit in credit-report update 190 to a corresponding one of entity units 155a-155d in credit information 150 when parsing credit-report update 190. Credit-management system 130 may then request the operator to select further action to be taken with respect to the unallocated entity unit in credit-report update 190. For example, the operator may correct portions of the unallocated entity unit in order to enable successful allocation of that entity unit.

If credit-management system 130 does not finish successfully processing credit-report update 190, such as because of an error in allocating sets of update information or updating corresponding sets of established credit information, credit-information provider 120 may register the update information that remains to be processed in a worklist 260. In one example, all of the update information is registered in worklist 260; in this example, the update information that remains to be processed may be registered in a section of worklist 260, which is referred to herein as an “unresolved worklist.” Worklist 260 may be retained at credit-management system 130 at least until a later time at which a subsequent credit-report update is transmitted from credit-information provider 120 for processing. At this later time, any necessary corrections to update information may be incorporated into the subsequent credit-report update to enable credit-management system 130 to complete updating credit information 150 according to the update information registered in worklist 260.

In an illustrative example, credit-report update 190 contains update information with an identifier entry that identifies an entity by DUNS-number, but the DUNS-number does not correspond to any of entity units 155a-155d in credit information 150. The update information may be registered in worklist 260. Credit-management system 130 may inform credit-information provider 120 of the erroneous DUNS-number such that credit-information provider 120 can include a corrected DUNS-number in the next credit-report update. When credit-management system 130 receives the corrected DUNS-number in the next credit-report update, credit-mangement system 130 can resume processing the previous credit-report update 190 based on worklist 260. In this manner, credit-management system 130 can use worklist 260 to insure that update information is not lost before it can be successfully processed. Worklist 260 may also improve the efficiency of transmissions between credit-management system 130 and credit-information provider 120. Alternatively, credit-management system 130 may request the subsequent re-transmission of the entire credit-report update 190 if the credit-report update 190 could not be successfully processed in its entirety at the previous time.

Credit-management system 130 may maintain a processing log 270 that records the current status of processing credit-report updates 190 in relation to each of the corresponding entities. For example, processing log 270 may contain a unique identifier of credit-information provider 120 from which credit-report updates 190 are received. Processing log 270 may also contain identifiers of the entities corresponding to credit-report updates 190, where the identifiers may include one or more of a key (such as the DUNS-number described above), a name, and an address of each of the entities. Processing log 270 may also describe, in relation to each of the entities, one or more of the following: a type of update information that is available for the entity, an old credit rating of the entity, a new credit rating of the entity, and a status flag indicating whether credit information 150 has been successfully updated in relation to the entity.

Processing log 270 may further contain a message indicating an error, warning, or other information relating to an attempt to process credit-report update 190. For example, an error message may be generated if, within credit information 150, an entity unit could not be found that corresponds to an entity unit to be allocated from credit-report update 190. A different error message may be generated if an attempt to update credit information 150 in relation to an otherwise successfully-allocated entity unit from credit-report update 190 failed. A warning message may be generated if multiple entities with the same information-provider-specific identifier are described in credit information 150. Furthermore, an information message may be generated if update information is available in credit-update report 190 for a particular entity, but update information was not requested for that particular entity. In addition to recording these messages in processing log 270, the messages may be displayed to the human operator in real-time by means of the UI such that the operator can take appropriate action.

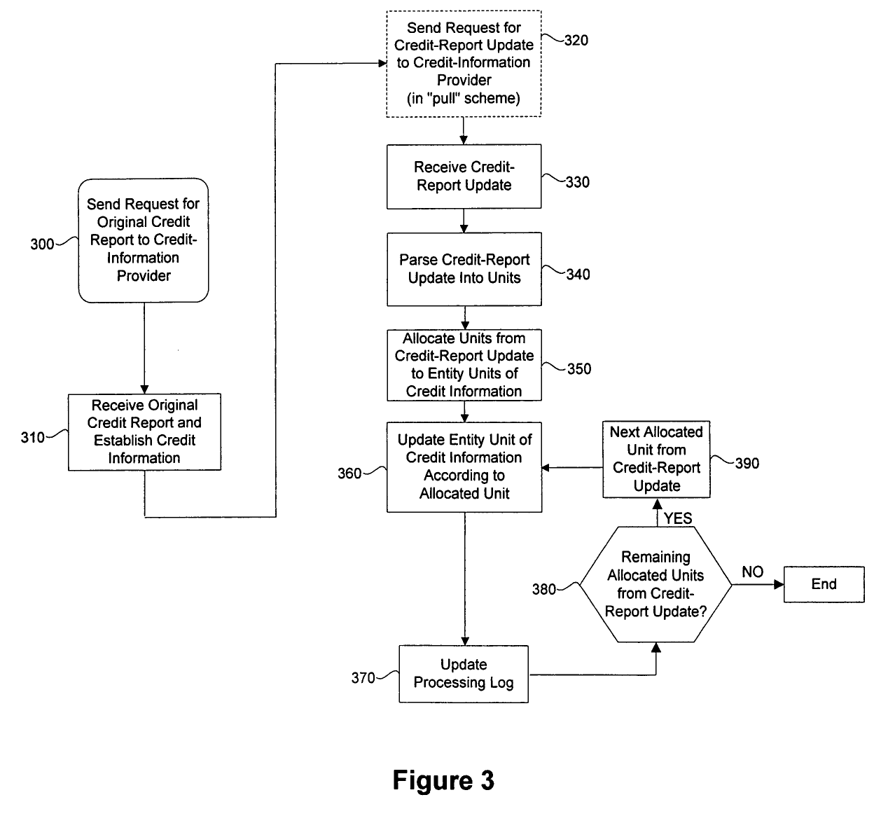

FIG. 3 is a flowchart of an exemplary embodiment, consistent with the present invention, of a method of maintaining credit information at a user. In FIG. 3, the rectangular boxes represent processes of the method, whereas the hexagonal boxes represent conditional branches of the method. To initially establish the credit information, the user sends a request for an original credit report to a credit-information provider, as shown by step 300. The user receives the original credit report from the credit-information provider and establishes the credit information, as shown by step 310.

Once the credit information is established at the user, the credit information can be kept up-to-date based on credit-report-updates from the credit-information provider. In an implementation of a “pull” scheme, as described above, the user sends a request for a credit-report-update to the credit-information provider, as shown by step 320. The user then receives a credit-report update from the credit-information provider, as shown by step 330. At the user, the credit-report update is parsed into separate units of update information corresponding to individual entities, as shown by step 340, and those units are allocated to corresponding entity units of the credit information, as shown by step 350.

For each entity for which update information is provided in the credit-report update, the credit information at the user is updated. For an individual allocated unit of update information, the corresponding entity unit of the credit information is updated according to the allocated unit, as shown by step 360. The user also updates a processing log to record a status of processing the credit-report update, as shown by step 370. The user determines whether any of the allocated units from the credit-report update remain to be applied as updates to the credit information, as shown by conditional branch 380. If an allocated unit of update information remains, then a next remaining allocated unit is selected, as shown by step 390, and step 360 is repeated for that next allocated unit. This cycle of sequentially updating entity units of the credit information continues until the credit information has been updated for all of the allocated units from the credit-update report.

The methods and systems disclosed herein may be embodied in various forms including, for example, a data processor or computer that also includes a database. Further, the elements or components described with reference to the exemplary drawings may be implemented through any suitable combination of hardware, software, and/or firmware. By way of example, the above-noted features and other aspects and principles of the present invention may be implemented in various environments. Such environments and related applications may be specifically constructed for performing the various processes and operations according to the invention, or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programmable instructions written in accordance with teachings of the invention, or it may be more convenient to construct a specialized apparatus to perform the required methods and techniques.

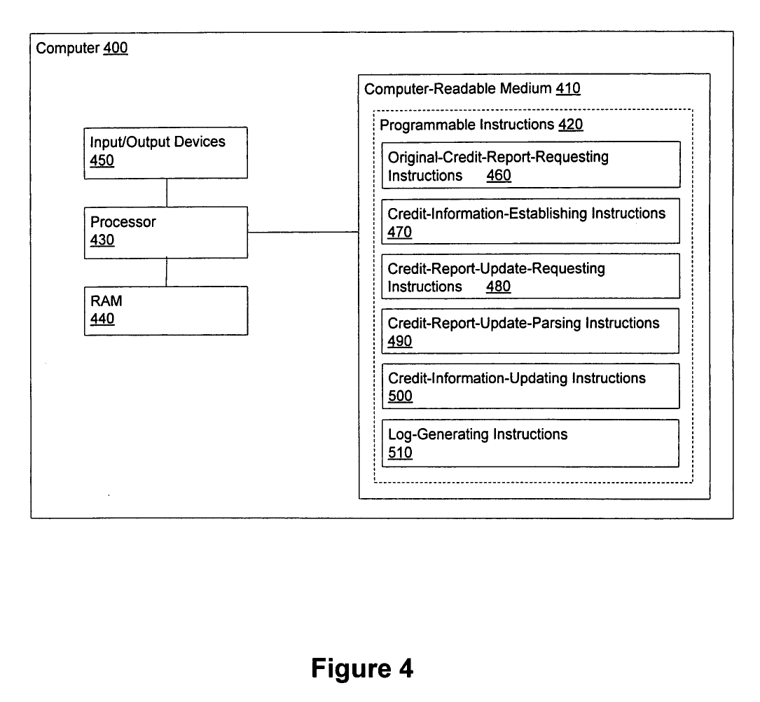

The credit-management system described herein may be implemented as credit-management software that is executed on a computer at the user to update the credit information. FIG. 4 is a block diagram of an exemplary embodiment, consistent with the present invention, of a computer 400 comprising a computer-readable medium 410 that contains programmable instructions 420, and a processor 430 to execute programmable instructions 420. Computer 400 may comprise a random-access memory (RAM) 440, such as a solid-state RAM, to temporarily store data. Input/output devices 450 may also be provided to communicate with external devices and/or a human operator. In accordance with one embodiment, SAP® Credit Management software, available from SAP AG, Walldorf, Germany, is installed as programmable instructions 420 on the computer to implement the credit-management system.

Programmable instructions 420 may include original-credit-report-requesting instructions 460 to request an original credit report from the credit-information provider. Credit-information-establishing instructions 470 may be provided to establish the credit information according to the original credit report. In addition, credit-report-update-requesting instructions 480 may be provided to request credit-report updates from the credit-information provider. Credit-report-update-parsing instructions 490 may be provided to parse the credit-report updates and thereby allocate update information to appropriate entities. Credit-information-updating instructions 500 may be provided to update the credit information according to the allocated update information from the credit-report updates. For example, credit-information-updating instructions 500 may include “Business Add-in” (BAdI) software to update the data fields of the credit information according to corresponding data fields of the credit-report updates. In addition, programmable instructions 420 may include log-generating instructions 510 to generate a processing log that describes the processing of the credit-report updates.

The data storage of the user, which may store the credit information relating to the entities and can also store the processing log, may be implemented in computer 400. For example, the data storage may be implemented in computer-readable medium 410. The data storage may additionally or alternatively be implemented in another computer-readable medium, such as RAM 440 or one or more additional memories. The mail server of the user may also be implemented in computer 400, such as in computer-readable medium 410, RAM 440, or another computer-readable medium.

Computer 400 of FIG. 4 is provided only to illustrate an exemplary embodiment of the invention and, thus, should not be used to limit the scope of the invention or its equivalents. For example, computer 400 may be distributed across a plurality of physically-separate computers that are communicatively coupled to one another. Computer-readable medium 410 and/or RAM 440 may also be distributed across a plurality of physically separate computer-readable media.

The methods, systems, and computer-readable media described herein can automatically update credit information that a user maintains in relation to one or more entities, such as business partners. The credit information can also be updated in a manner that efficiently uses transmissions between the user and one or more credit-information providers.

The foregoing description of possible implementations and embodiments consistent with the present invention does not represent a comprehensive list of all such implementations or all variations of the implementations described. The description of only some implementations should not be construed as an intent to exclude other implementations or embodiments. One of ordinary skill in the art will understand how to implement the invention in the appended claims in other ways, using equivalents and alternatives that do not depart from the scope of the following claims.

What is claimed is:

1. A method of maintaining credit information that relates to one or more entities, the method comprising:
receiving a credit report from a credit-information provider to establish one or more units of credit information, each of the units of credit information relating to an entity;
receiving a credit-report update from the credit-information provider, the credit-report update comprising a unit of update information that relates to an entity;
determining whether the unit of update information corresponds to one of the units of established credit information; and
if there is correspondence, updating the corresponding unit of credit information according to the unit of update information.

2. The method of claim 1, wherein the credit-report update comprises a plurality of units of update information, each of the units of update information relating to an entity, and, for each of the units of update information, further comprising (i) determining whether the unit of update information corresponds to one of the units of established credit information and (ii) if there is correspondence, updating the corresponding unit of established credit information according to the unit of update information.

3. The method of claim 1, further comprising, before receiving the credit-report update, requesting the credit-report update from the credit-information provider.

4. The method of claim 3, wherein requesting the credit-report update from the credit-information provider comprises accessing a mailbox of the credit-information provider, determining whether the credit-report update is present in the mailbox, and, if the credit-report update is present, retrieving the credit-report update from the mailbox.

5. The method of claim 1, wherein updating the unit of credit information comprises updating a data field in the credit information according to a corresponding data field in the unit of update information.

6. The method of claim 1, wherein updating the unit of credit information comprises creating a new data field in the credit information according to a corresponding data field in the unit of update information.

7. The method of claim 1, further comprising, if there is not correspondence between the unit of update information and one of the units of established credit information, displaying an error message to a human operator.

8. The method of claim 7, further comprising receiving an input from the human operator to determine a further action to be taken in relation to the credit-report update.

9. The method of claim 1, further comprising, if there is an error in processing the credit-report update, receiving a subsequent credit-report update from the credit-information provider, the subsequent credit-report update comprising update information that was not previously successfully processed and excluding update information that was previously successfully processed.

10. A system for maintaining credit information that relates to one or more entities, the system comprising:
a credit-management system adapted to:
(i) receive a credit report from a credit-information provider to establish one or more units of credit information, each of the units of credit information relating to an entity,
(ii) receive a credit-report update from the credit-information provider, the credit-report update comprising a unit of update information that relates to an entity,
(iii) determine whether the unit of update information corresponds to one of the units of established credit information, and
(iv) if there is correspondence, updating the corresponding unit of credit information according to the unit of update information; and
a data storage to store the credit information.

11. The system of claim 10, wherein the credit-report update comprises a plurality of units of update information, each of the units of update information relating to an entity, and wherein the credit-management system is further adapted to, for each of the units of update information, (i) determine whether the unit of update information corresponds to one of the units of established credit information and (ii) if there is correspondence, update the corresponding unit of established credit information according to the unit of update information.

12. The system of claim 10, wherein the credit-management system is further adapted to, before receiving the credit-report update, request the credit-report update from the credit-information provider.

13. The system of claim 12, wherein the credit-management system is adapted to access a mailbox of the credit-information provider, determine whether the credit-report update is present in the mailbox, and, if the credit-report update is present, retrieve the credit-report update from the mailbox.

14. The system of claim 10, wherein the credit-management system is adapted to update a data field in the credit information according to a corresponding data field in the unit of update information.

15. The system of claim 10, wherein the credit-management system is adapted to create a new data field in the credit information according to a corresponding data field in the unit of update information.

16. The system of claim 10, wherein, the credit-management system is further adapted to, if there is not correspondence between the unit of update information and one of the units of established credit information, display an error message to a human operator.

17. The system of claim 16, wherein the credit-management system is further adapted to receive an input from the human operator to determine a further action to be taken in relation to the credit-report update.

18. The system of claim 10, wherein the credit-management system is further adapted to, if there is an error in processing the credit-report update, receive a subsequent credit-report update from the credit-information provider, the subsequent credit-report update comprising update information that was not previously successfully processed and excluding update information that was previously successfully processed.

19. A computer-readable medium comprising programmable instructions adapted to perform a method of maintaining credit information that relates to one or more entities, the method comprising:
receiving a credit report from a credit-information provider to establish one or more units of credit information, each of the units of credit information relating to an entity;
receiving a credit-report update from the credit-information provider, the credit-report update comprising a unit of update information that relates to an entity;
determining whether the unit of update information corresponds to one of the units of established credit information; and
if there is correspondence, updating the corresponding unit of credit information according to the unit of update information.

20. The computer-readable medium of claim 19, wherein the credit-report update comprises a plurality of units of update information, each of the units of update information relating to an entity, and wherein the method further comprises, for each of the units of update information, (i) determining whether the unit of update information corresponds to one of the units of established credit information and (ii) if there is correspondence, updating the corresponding unit of established credit information according to the unit of update information.

21. The computer-readable medium of claim 19, wherein the method further comprises, before receiving the credit-report update, requesting the credit-report update from the credit-information provider.

22. The computer-readable medium of claim 21, wherein requesting the credit-report update from the credit-information provider comprises accessing a mailbox of the credit-information provider, determining whether the credit-report update is present in the mailbox, and, if the credit-report update is present, retrieving the credit-report update from the mailbox.

23. The computer-readable medium of claim 19, wherein updating the unit of credit information comprises updating a data field in the credit information according to a corresponding data field in the unit of update information.

24. The computer-readable medium of claim 19, wherein updating the unit of credit information comprises creating a new data field in the credit information according to a corresponding data field in the unit of update information.

25. The computer-readable medium of claim 19, wherein the method further comprises, if there is not correspondence between the unit of update information and one of the units of established credit information, displaying an error message to a human operator.

26. The computer-readable medium of claim 25, wherein the method further comprises receiving an input from the human operator to determine a further action to be taken in relation to the credit-report update.

27. The computer-readable medium of claim 19, wherein the method further comprises, if there is an error in processing the credit-report update, receiving a subsequent credit-report update from the credit-information provider, the subsequent credit-report update comprising update information that was not previously successfully processed and excluding update information that was previously successfully processed.
